(19) United States
(12) Patent Application Publication
(10) Pub. No.: US 2023/0389143 A1
(43) Pub. Date: Nov. 30, 2023

(54) MICROWAVE TREATMENT DEVICE

(71) Applicant: Panasonic Intellectual Property Management Co., Ltd., Osaka (JP)

(72) Inventors: YOSHIHARU OOMORI, Shiga (JP); DAISUKE HOSOKAWA, Shiga (JP); TAKASHI UNO, Shiga (JP)

(21) Appl. No.: 18/249,407

(22) PCT Filed: Jan. 7, 2022
(86) PCT No.: PCT/JP2022/000426

§ 371 Date: Apr. 18, 2023

(30) Foreign Application Priority Data
Feb. 1, 2021 (JP) 2021-014070

(51) Int. Cl. H05B 6/68; H05B 6/66

(52) U.S. Cl. CPC H05B 6/687; H05B 6/664

(57) ABSTRACT

In a microwave treatment device according to the present disclosure, a controller selects a plurality of frequencies in a predetermined frequency band and causes a microwave generator to generate microwaves of a selected frequency. The controller causes the amplifier to change the output power level of the microwaves and to thereby supply the microwaves of one of a plurality of output power levels to the heating chamber. The controller measures a reflected wave frequency characteristic based on a radiated power and a reflected power. The controller calculates a linear component and a non-linear component of a power loss consumed by the heating chamber based on the reflected wave frequency characteristic. The controller estimates an amount of absorption power absorbed by a heating target based on the power loss obtained by combining the linear component and the non-linear component.

### TECHNICAL FIELD

The present disclosure relates to a microwave treatment device equipped with a microwave generator.

### BACKGROUND ART

A conventional microwave heating apparatus is known that changes an oscillation state of a semiconductor oscillator, such as an oscillation frequency and an oscillation level, according to the amount of reflected wave (see, for example, PTL 1). This conventional microwave heating apparatus is intended to protect an amplifier from reflected waves and improve efficiency at low cost by changing an oscillation state.

A microwave treatment device is also known that determines a frequency of microwaves for heating by performing frequency sweeping before heating a heating object (see, for example, PTL 2). This conventional microwave treatment device determines the frequency of microwaves for heating to be a frequency at which the reflected power detected while performing frequency sweeping becomes smallest or minimum.

The just-described conventional device is intended to improve power conversion efficiency and prevent breakage of a microwave generating device resulting from reflected power.

A drying device using microwaves is also known (see, for example, PTL 3). This conventional drying device obtains the mean value of differences between the amount of radiated power and the amount of reflected power of microwaves, and ends or temporarily suspends microwave heating at the time when the mean value reaches a target mean value. This conventional drying device is intended to obtain a highly accurate dried product by determining the completion of drying based on the mean value of differences between the amount of radiated power and the amount of reflected power.

### CITATION LIST

### Patent Literature

PTL 1: Japanese Patent Unexamined Publication No. S56-134491
PTL 2: Japanese Patent Unexamined Publication No. 2008-108491
PTL 3. Japanese Patent Unexamined Publication No. H11-83325

### SUMMARY

However, in a heating chamber of a microwave treatment device such as the microwave heating apparatus and the microwave drying device, there exists a loss of microwaves caused by the structure of the heating chamber, in addition to absorption of microwaves by a heating target. In particular, when a vitreous enameling process is performed over a wide area of wall surfaces of the heating chamber, the loss of microwaves caused by the structure of the heating chamber is significant, which causes the detected amount of reflected power to be small. In this case, it is difficult to distinguish whether the small amount of reflected power is due to the absorption of microwaves by the heating target or due to the loss of microwaves caused by the structure of the heating chamber.

If it is unable to identify the absorption of microwaves by the heating target based on the information of reflected power, it is difficult to operate the microwave treatment device with high efficiency. In this case, it is necessary to provide an element, such as a temperature sensor, for identifying the progress of cooking, in order to carry out cooking reliably. This increases the cost of the microwave treatment device.

Moreover, it is impossible to accurately identify the absorption of microwaves by the heating target only from the amount of radiated power and the amount of reflected power of microwaves. In this case, it is difficult to determine the end of heating accurately.

It is an object of the present disclosure to provide a microwave treatment device that is able to perform desired cooking for various shapes, types, and amounts of heating targets.

A microwave treatment device according to an embodiment of the present disclosure includes a heating chamber accommodating a heating target, a microwave generator, an amplifier, a power feeder, a detector, and a controller.

The microwave generator generates microwaves having a given frequency in a predetermined frequency band. The amplifier amplifies an output power level of the microwaves generated by the microwave generator. The power feeder irradiates the heating chamber with the microwaves amplified by the amplifier as a radiated power. The detector detects the radiated power and a reflected power of the radiated power that returns from the heating chamber to the power feeder. The controller controls the microwave generator and the amplifier based on information from the detector to control heating to the heating target.

The controller selects a plurality of frequencies in the predetermined frequency band and causes the microwave generator to generate microwaves of the selected frequencies. The controller causes the amplifier to change the output power level of the microwaves and to thereby supply the microwaves of one of a plurality of output power levels to the heating chamber.

Based on the radiated power and the reflected power, the controller calculates a component related to a housing of the microwave treatment device and a component obtained during heating, and combines the calculated components together. Thereby, the controller calculates a power loss consumed by the heating chamber and estimates an amount of absorption power absorbed by the heating target based on the power loss.

A microwave treatment device according to the present disclosure is able to identify the progress of cooking accurately and to perform appropriate cooking for various shapes, types, and amounts of heating targets.

### BRIEF DESCRIPTION OF THE DRAWINGS

FIG. 1 is a schematic configuration view illustrating a heating device according to an exemplary embodiment of the present disclosure.

FIG. 2 is a graph illustrating reflected wave frequency characteristics for three types of radiated power.

FIG. 3A is a graph schematically illustrating the relationship between supplied power and absorption power absorbed by a heating target when only a linear component of power loss is taken into consideration.

FIG. 3B is a graph schematically illustrating the relationship between supplied power and absorption power absorbed by the heating target when a linear component and a non-linear component of power loss are taken into consideration.

FIG. 4A is a graph schematically illustrating an example of experimental results in which supplied power and absorption power absorbed by a heating target are measured.

FIG. 4B is a graph schematically illustrating another example of experimental results in which supplied power and absorption power absorbed by a heating target are measured.

FIG. 5 is a graph illustrating a correlation between a warp of quadratic curve and output difference characteristics.

FIG. 6 is a graph of a temperature rise characteristic showing the relationship between an amount of absorption power of a heating target and a temperature rise of the heating target.

FIG. 7A is a flowchart illustrating a main flow of cooking control.

FIG. 7B is a flowchart illustrating a flow of a sensing process.

FIG. 7C is a flowchart illustrating a flow of an estimation process for an amount of absorption power.

FIG. 7D is a flowchart illustrating a flow of an estimation process for a temperature rise.

### DESCRIPTION OF EMBODIMENTS

A microwave treatment device according to a first aspect of the present disclosure includes a heating chamber accommodating a heating target, a microwave generator, an amplifier, a power feeder, a detector, and a controller.

The microwave generator generates microwaves having a given frequency in a predetermined frequency band. The amplifier amplifies an output power level of the microwaves generated by the microwave generator. The power feeder irradiates the heating chamber with the microwaves amplified by the amplifier as a radiated power. The detector detects the radiated power and a reflected power of the radiated power that returns from the heating chamber to the power feeder. The controller controls the microwave generator and the amplifier based on information from the detector to control heating to the heating target.

The controller selects a plurality of frequencies in the predetermined frequency band and causes the microwave generator to generate microwaves of the selected frequencies. The controller causes the amplifier to change the output power level of the microwaves and to thereby supply the microwaves of one of a plurality of output power levels to the heating chamber.

Based on the radiated power and the reflected power, the controller calculates a component related to a housing of the microwave treatment device and a component obtained during heating, and combines the calculated components together. Thereby, the controller calculates a power loss consumed by the heating chamber and estimates an amount of absorption power absorbed by the heating target based on the power loss.

In a microwave treatment device according to a second aspect of the present disclosure, in addition to the first aspect, the controller measures a reflected wave frequency characteristic based on the radiated power and the reflected power. The controller calculates a linear component of the power loss based on a first coefficient related to the housing of the microwave treatment device. The controller calculates a non-linear component of the power loss based on a second coefficient determined by the reflected wave frequency characteristic obtained during heating.

In a microwave treatment device according to a third aspect of the present disclosure, in addition to the second aspect, the controller calculates the non-linear component of the power loss by approximating a characteristic of the non-linear component of the power loss by a quadratic curve.

In a microwave treatment device according to a fourth aspect of the present disclosure, in addition to the third aspect, the controller causes the amplifier to change the output power level of the microwaves into a first output power level and a second output power level that is higher than the first output power level, among the plurality of output power levels.

The controller measures a first reflected wave frequency characteristic for the microwaves of the first output power level, and a second reflected wave frequency characteristic for the microwaves of the second output power level. The controller obtains an output power difference characteristic that is a difference between the first reflected wave frequency characteristic and the second reflected wave frequency characteristic. The controller uses a coefficient determined according to the output power difference characteristic as the second coefficient, and multiplies the output power difference characteristic by the second coefficient to obtain the quadratic curve.

In a microwave treatment device according to a fifth aspect of the present disclosure, in the first aspect, the controller multiplies the amount of absorption power absorbed by a third coefficient determined according to a temperature rise characteristic indicating a relationship between the amount of absorption power and a temperature rise of the heating target, to thereby estimate the temperature rise.

In a microwave treatment device according to a sixth aspect of the present disclosure, in addition to the second aspect, the controller calculates the linear component of the power loss by approximating a characteristic of the non-linear component of the power loss separately for a case of defrosting heating and for a case of temperature-raising heating. The term “defrosting heating” means heating the heating target in a frozen state, in which the temperature is less than 0° C., and in a defrosting state, in which the temperature is approximately 0° C. The term “temperature-raising heating” means heating to raise the temperature of the heating target in a defrosted state, in which the temperature is higher than or equal to 0° C.

In a microwave treatment device according to a seventh aspect of the present disclosure, in addition to the sixth aspect, the controller deducts a heat of fusion required for the defrosting heating from the amount of absorption power absorbed by the heating target, to calculate a remaining amount of absorption power. The controller multiplies the remaining amount of absorption power absorbed by a third coefficient determined according to a temperature rise characteristic in the temperature-raising heating, to thereby estimate the temperature rise.

In a microwave treatment device according to an eighth aspect of the present disclosure, in addition to the second aspect, the controller updates a heating condition as the heating proceeds, and calculates the linear component and the non-linear component of the power loss each time the heating condition is updated.

In a microwave treatment device according to a ninth aspect of the present disclosure, in addition to the fourth aspect, the controller detects all frequency bands in which the difference between the first reflected wave frequency characteristic and the second reflected wave frequency characteristic exceeds a predetermined threshold value to be cavity interior loss frequency bands. The controller updates a heating condition as cooking proceeds, and calculates the linear component and the non-linear component of the power loss in all the cavity interior loss frequency bands each time the heating condition is updated.

Hereafter, exemplary embodiments of the present disclosure will be described with reference to the drawings.

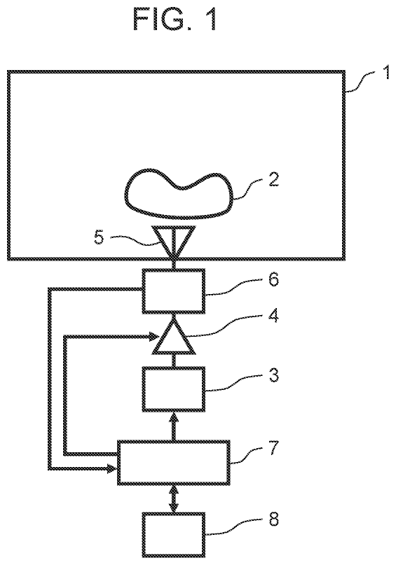

FIG. 1 is a schematic configuration view illustrating a heating apparatus according to the present exemplary embodiment of the disclosure. As illustrated in FIG. 1, a microwave treatment device according to the present exemplary embodiment includes heating chamber 1, microwave generator 3, amplifier 4, power feeder 5, detector 6, controller 7, and memory 8.

Heating chamber 1 accommodates heating target 2, such as a food product, which is the load. Microwave generator 3 includes a semiconductor element. Microwave generator 3 is able to generate microwaves having a given frequency in a predetermined frequency band, and generates microwave power with a frequency designated by controller 7.

Amplifier 4 includes a semiconductor element. Amplifier 4 amplifies an output power level of the microwave power generated by microwave generator 3 according to an instruction from controller 7, and outputs a microwave power of the amplified output power level.

Power feeder 5 includes an antenna for radiating microwaves, and supplies the microwaves amplified by amplifier 4 as radiated power to heating chamber 1. In other words, power feeder 5 supplies the radiated power to heating chamber 1 based on the microwaves generated by microwave generator 3. Part of the radiated power that is not consumed by heating target 2 or the like becomes the reflected power returning from heating chamber 1 to power feeder 5.

Detector 6 may be composed of, for example, a directional coupler. Detector 6 detects amounts of the radiated power and the reflected power and notifies controller 7 of the information thereof. That is, detector 6 functions as both a radiated power detector and a reflected power detector.

Detector 6 has a degree of coupling of about −40 dB, for example, and detects an electric power of about 1/10000 of the radiated power and the reflected power. The detected radiated power and the detected reflected power are rectified by a detector diode (not shown), smoothed by a capacitor (not shown), and converted into pieces of information corresponding to the amounts of the radiated power and the reflected power. Controller 7 receives these pieces of information from detector 6.

Memory 8 includes, for example, a semiconductor memory. Memory 8 stores predetermined data and data transmitted from controller 7, and reads out the stored data to transmit the read data to controller 7. Specifically, memory 8 stores the amounts of the radiated power and the reflected power that have been detected by detector 6 and the information related to the reflected power, together with the frequency of microwaves and the elapsed time from the start of heating.

Controller 7 is composed of a microprocessor including a central processing unit (CPU). Controller 7 estimates a temperature rise of heating target 2 based on the information from detector 6 and memory 8 and controls microwave generator 3 and amplifier 4 to control heating to heating target 2. When heating target 2 is a food product, the microwave treatment device is a heating cooker, and the heating to heating target 2 is cooking for the food product.

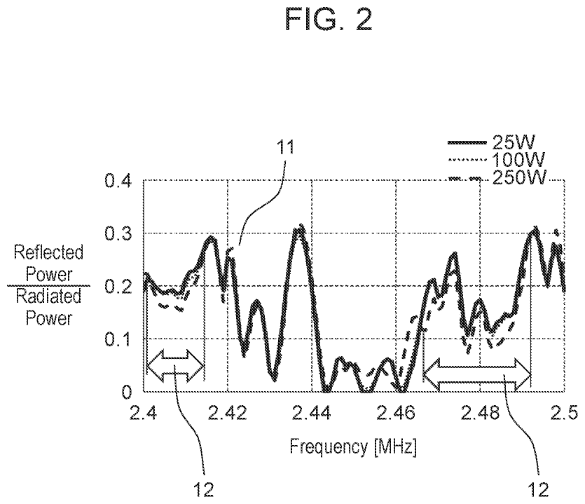

FIG. 2 shows the frequency characteristics of reflected power in the present exemplary embodiment. The electric power consumed by heating target 2, the power loss consumed by the structure made of vitreous enamel or the like inside heating chamber 1, and the electric power accumulated by the resonance in heating chamber 1 are dependent on the frequency of microwaves. As the frequency changes, the total power consumption of the microwaves consumed in heating chamber 1 changes, and the amount of the reflected power also changes accordingly.

In other words, the reflected power changes depending on the type of heating target 2, the material of the wall surfaces of heating chamber 1, and the frequency of microwaves. Due to such changes, the amount of power loss of microwaves in heating chamber 1 changes, and the amount of reflected power also changes correspondingly.

The frequency characteristics of reflected power shown in FIG. 2 are such that each piece of information related to the reflected power for each frequency of microwaves is depicted in a graph, with the horizontal axis representing frequency (MHz) and the vertical axis representing information related to the reflected power. Hereinafter, the frequency characteristic of the reflected power is referred to as reflected wave frequency characteristic 11. In the present exemplary embodiment, the information related to the reflected power is the proportion of the reflected power relative to the radiated power. Hereinafter, the proportion of the reflected power relative to the radiated power is referred to as a reflection rate.

FIG. 2 shows reflected wave frequency characteristics 11 for three levels of radiated power, 25 W (solid line), 100 W (dotted line), and 250 W (dashed line). As illustrated in FIG. 2, there exist frequency bands in which reflected wave frequency characteristics 11 are significantly different due to the differences in the magnitude of radiated power.

In these frequency bands, the reflected power in the case of a radiated power of 250 W (dashed line) is smaller than in the cases of the other output power levels. That is, in these frequency bands, a non-linear component of the power loss consumed by the structure of heating chamber 1 is greater. Hereinafter, the power loss consumed by the structure of heating chamber 1 is simply referred to as power loss consumed by heating chamber 1. The term “cavity interior loss frequency band 12” means a frequency band in which the difference between reflected wave frequency characteristic 11 for the radiated power of 250 W and reflected wave frequency characteristic 11 for the radiated power of 25 W exceeds a predetermined threshold value. The non-linear component of power loss will be described later.

The electric power values of the radiated power are not limited to 25 W and 250 W mentioned above. The lower one of the radiated powers may not be 25 W, and may be less than 100 W, desirably less than 50 W. The higher one of the radiated powers may not be 250 W, and may be higher than or equal to 100 W, desirably higher than or equal to 200 W.

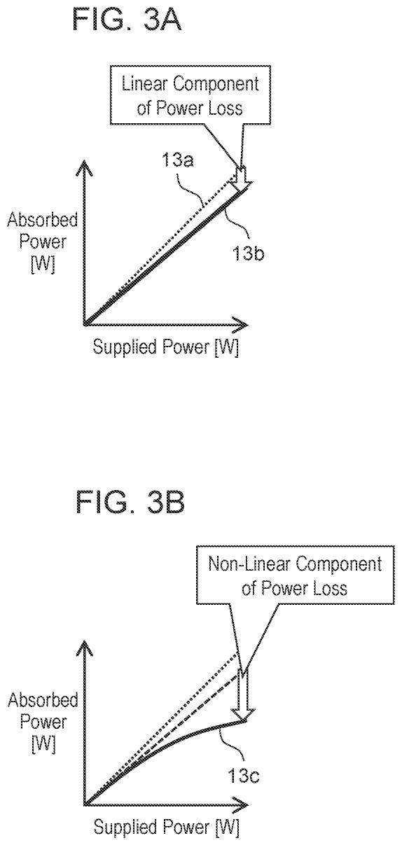

FIGS. 3A and 3B schematically show the relationship between supplied power (horizontal axis) and absorption power absorbed by heating target 2 (vertical axis). The term “supplied power” means the electric power consumed in heating chamber 1, obtained by deducting the reflected power from the radiated power. The term “absorption power absorbed by heating target 2” means the electric power that is absorbed by heating target 2.

As illustrated in FIG. 3A, when the supplied power is higher, the absorption power absorbed by heating target 2 is accordingly higher. When there is no electric power consumed in heating chamber 1 other than the absorption power absorbed by heating target 2, the supplied power is equal to the absorption power absorbed by heating target 2.

Specifically, the relationship between the supplied power and the absorption power absorbed by heating target 2 in this case is shown by characteristic line 13a, which is indicated by the dotted line in FIG. 3A.

In reality, however, heating chamber 1 including metal wall surfaces subjected to a vitreous enameling process produces a power loss that is approximately proportional to the supplied power due to the factors associated with the housing structure of the microwave treatment device. That is, this power loss has a linear characteristic with respect to the supplied power.

The factors associated with the housing structure of the microwave treatment device include Joule losses due to high frequency current on the metal wall surfaces, induction losses resulting due to glass or resin components of the door that closes the front opening of heating chamber 1, and so forth.

Therefore, this power loss can be calculated by multiplying the supplied power by a coefficient that is predetermined based on such a linear characteristic. Hereinafter, the component of the power loss having a linear characteristic with respect to the supplied power is referred to as a linear component of the power loss consumed by heating chamber 1. The coefficient for calculating the linear component of the power loss is referred to as a first coefficient.

When the linear component of the power loss is taken into consideration, the absorption power absorbed by heating target 2 is obtained by subtracting this linear component of the power loss from the supplied power (characteristic line 13a). The relationship between the supplied power and the absorption power absorbed by heating target 2 in this case is shown by characteristic line 13b, which is indicated by the solid line in FIG. 3A. That is, the slope of characteristic line 13b corresponds to the first coefficient.

In addition, in the case of heating chamber 1 having wall surfaces subjected to a vitreous enameling process, a power loss arises in the vicinity of the bonded portion between glass and metal base material in the vitreous enamel. The electrical insulation in the bonded portion is maintained when the supplied power is low and the electric field is weak.

However, as illustrated in FIG. 3B, when the supplied power increases and the electric field becomes stronger, the loss in the bonded portion increases abruptly. As a consequence, when the supplied power increases, the absorption power does not become as high as that when the supplied power is low. That is, this power loss has a non-linear characteristic with respect to the supplied power. The relationship between the supplied power and the absorption power absorbed by heating target 2 in this case is shown by characteristic line 13c, which is indicated by the solid line in FIG. 3B. Specifically, as the supplied power increases, the non-linear component of the power loss becomes greater non-linearly.

For this reason, it is necessary to determine the coefficient for calculating the power loss according to reflected wave frequency characteristic 11 that is measured for each of heating conditions during heating. Note that the heating conditions are the frequency and output power level of the radiated power. Hereinafter, the component of the power loss having a non-linear characteristic with respect to the supplied power is referred to as a non-linear component of the power loss consumed by heating chamber 1.

In the case of heating chamber 1 having metal wall surfaces subjected to a vitreous enameling process, the power loss consumed by heating chamber 1 is a combined value of the linear component and the non-linear component combined together. When the non-linear component of the power loss is not taken into consideration, the absorption power absorbed by heating target 2 when the supplied power is high is estimated to be higher than the actual value. As a consequence, heating target 2 cannot be heated sufficiently.

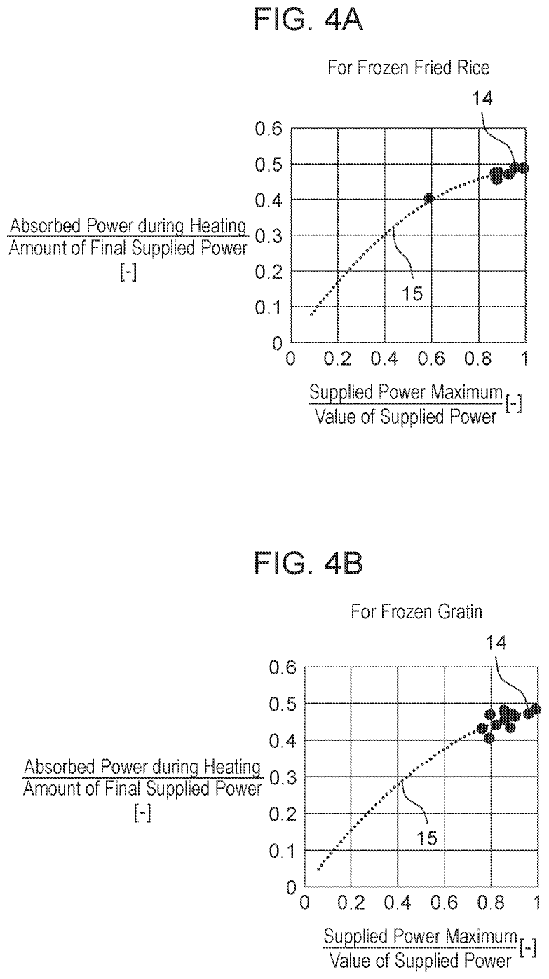

FIGS. 4A and 4B each show experimental results in which supplied power and absorption power absorbed by heating target 2 are measured. FIG. 4A shows the experimental results for the case where heating target 2 is frozen fried rice, and FIG. 4B shows the experimental results for the case where heating target 2 is frozen gratin.

The present inventors conducted a plurality of times an experiment of measuring the radiated power while varying the frequency band and calculating the absorption power absorbed by heating target 2 based on the temperature rise of heating target 2 that results from heating. In this experiment, heating chamber 1 having metal wall surfaces subjected to a vitreous enameling process was used. FIGS. 4A and 4B are each a graphical representation of data 14 that were obtained as the results of the experiment.

In each of FIGS. 4A and 4B, the vertical axis represents a dimensionless value of an amount of absorption power during heating that is normalized by dividing it by an amount of final supplied power. The horizontal axis represents a dimensionless value of each value of supplied power that is normalized by dividing it by a maximum value of supplied power. Note that the amount of supplied power is an integrated value of the supplied power, and the amount of absorption power absorbed by heating target 2 is an integrated value of the absorption power.

It can be seen that the characteristics shown in FIGS. 4B and 4B contain characteristics related to non-linear components of the power loss, which are similar to characteristic line 13c shown in FIG. 3B. These characteristics related to the non-linear components are approximated by quadratic curve 15, and the non-linear component of the power loss is calculated by utilizing quadratic curve 15.

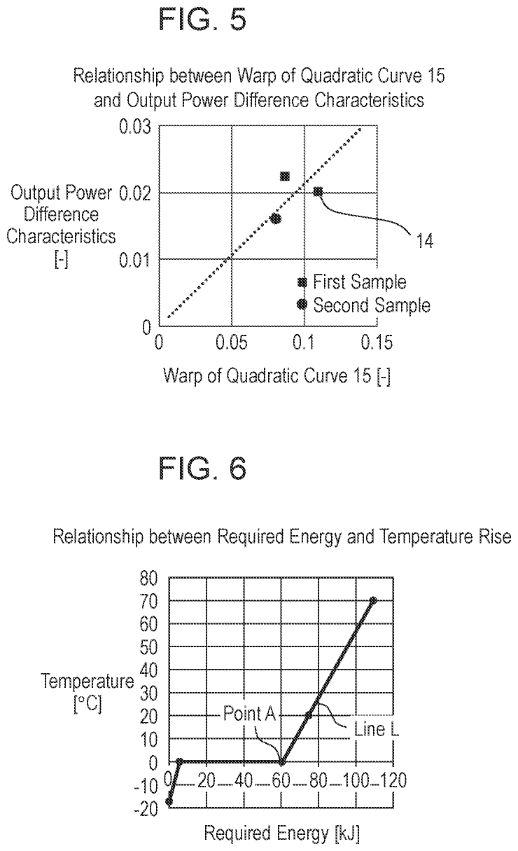

FIG. 5 shows the relationship between magnitude of warp of quadratic curve 15 shown in FIGS. 4A and 4B (horizontal axis) and output power difference characteristics (vertical axis). The term “output power difference characteristic” means a difference between two reflected wave frequency characteristics that are measured for two radiated powers with different output power levels as shown in FIG. 2.

In FIG. 5, the first sample and the second sample represent two types of housings used in the above-described experiments. The second sample is provided with heating chamber 1 having a smaller cavity interior capacity and a lower power loss than that of the first sample.

As seen from the dotted line in FIG. 5, a certain correlation is observed between the magnitude of warp of quadratic curve 15 and the output power difference characteristics. By multiplying the slope information of the dotted line shown in FIG. 5 by the output power difference characteristic obtained before and during heating, quadratic curve 15 for each heating condition is obtained, and the non-linear loss of the power loss is calculated. This slope information is the second coefficient for calculating the non-linear component of the power loss. The second coefficient is prestored in memory 8.

FIG. 6 is a graph of temperature rise characteristic, which shows the relationship between a required energy (amount of absorption power) by heating target 2 and a temperature rise of heating target 2. The specific heat is different between heating target 2 in a frozen state and heating target 2 in a defrosting state, so heat of fusion is necessary to cause the temperature of heating target 2 in a frozen state to exceed 0° C.

As illustrated in FIG. 6, most of the amount of absorption power absorbed by heating target 2 is consumed as heat of fusion from a frozen state, in which the temperature of heating target 2 is less than 0° C., to a defrosting state, in which the temperature is at or around 0° C. The heating in this case is hereinafter referred to as defrosting heating. The defrosting heating means heating and defrosting of frozen heating target 2.

In cases where heating target 2 is heated in a defrosted state, in which the temperature is higher than or equal to 0° C., the temperature rise of heating target 2 is proportional to the amount of absorption power absorbed by heating target 2 (see straight line L to the right of point A in FIG. 6). The heating in this case is hereinafter referred to as temperature-raising heating. The temperature-raising heating means that heating target 2 having a temperature of higher than or equal to 0° C. is heated to raise its temperature to a target temperature.

Thus, the temperature rise characteristics are different between the case of defrosting heating and the case of temperature-raising heating. Therefore, it is desirable to calculate the linear component of power loss separately for the defrosting heating and for the temperature-raising heating.

The vertical axis of each of the graphs shown in FIGS. 3A and 3B (amount of absorption power absorbed by heating target 2) corresponds to the horizontal axis of the graph shown in FIG. 6 (required energy by heating target 2).

As described above, the time integral value of the linear component and the non-linear component of the power loss is calculated from the amount of supplied power. The power loss is calculated by combining the linear component and the non-linear component, and the amount of absorption power absorbed by heating target 2 is calculates from the time integral value of the supplied power and the power loss. The temperature rise of heating target 2 can be estimated by applying the amount of absorption power absorbed by heating target 2 to the graph shown in FIG. 6.

When heating target 2 in a frozen state is cooked, the defrosting heating and the temperature-raising heating are performed to raise the temperature of heating target 2 by several tens of degrees. To do so, first, heat of fusion required for defrosting heating (fixed value) is subtracted from the amount of absorption power absorbed by heating target 2 according to the conditions of heating target 2 to calculate a remaining amount of absorption power. The conditions of heating target 2 include the type, amount, shape, and the like of heating target 2.

The temperature rise of heating target 2 can be estimated by multiplying the remaining amount of absorption power absorbed by the slope of the temperature rise (straight line L in FIG. 6) in the case of temperature-raising heating. The slope of straight line L that indicates the temperature rise characteristic in the case of temperature-raising heating is hereinafter referred to as a third coefficient.

Reflected wave frequency characteristic 11 in FIG. 2 is dependent on the conditions of heating target 2. Reflected wave frequency characteristic 11 is also affected by changes in physical properties of heating target 2 due to the temperature rise associated with the progress of cooking. Therefore, reflected wave frequency characteristic 11 is measured repeatedly during the cooking process, and the heating conditions are changed. Then, each time the heating conditions are updated, the linear component and the non-linear component of the power loss, which are the basis for estimating the temperature rise of heating target 2, are updated.

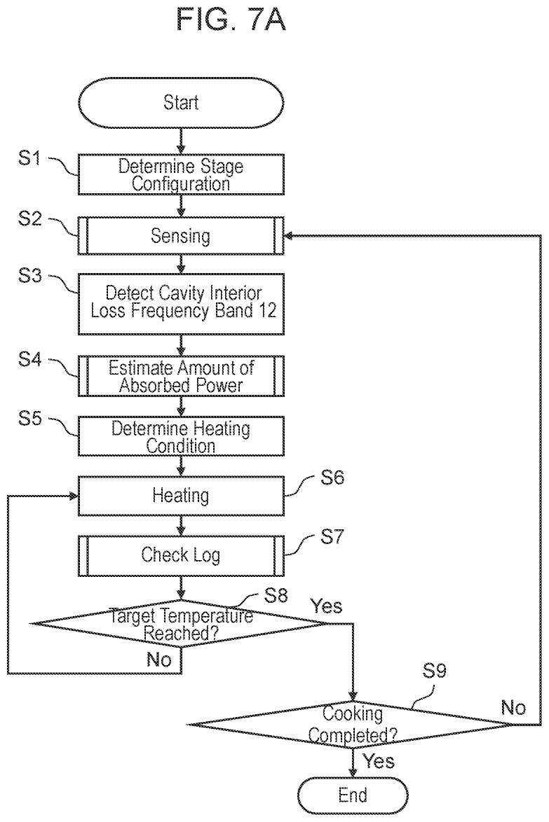

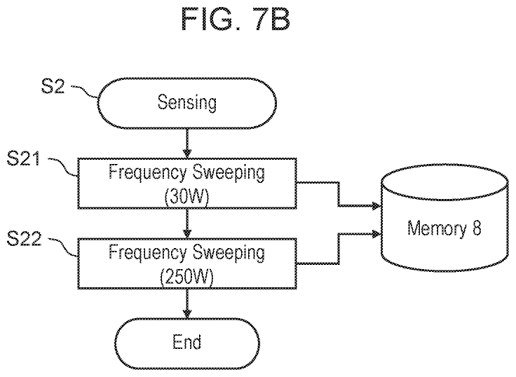

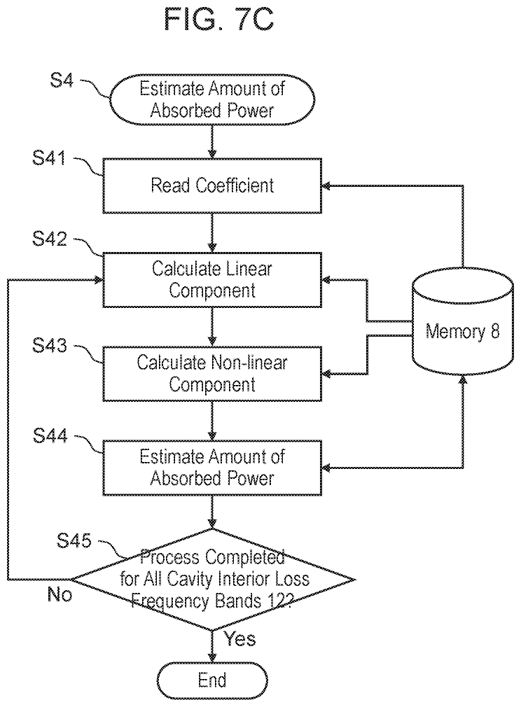

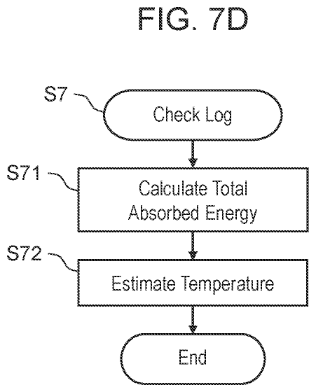

FIGS. 7A to 7D are flowcharts each illustrating a flow of cooking control in the present exemplary embodiment. FIG. 7A illustrates a main flow of cooking control. As illustrated in FIG. 7A, when the user selects a menu to start cooking, controller 7 determines a stage configuration (step S1).

The stage configuration includes all the cooking stages related to the selected menu, the sequence of the cooking stages, the transition timing to the next cooking stage, and the like. Thereafter, the controller performs a sensing process (step S2).

FIG. 7B shows a flow of the sensing process (step S2 in FIG. 7A). As illustrated in FIG. 7B, in the sensing process (step S2), controller 7 causes microwave generator 3 to perform frequency sweeping with microwaves at a first output power level (for example, 25 W) (step S21). The frequency sweeping is an operation of microwave generator 3 that changes the oscillation frequency over a predetermined frequency band sequentially at predetermined frequency intervals.

Specifically, microwave generator 3 generates microwaves while performing frequency sweeping, and amplifier 4 outputs a radiated power at the first output power level. Detector 6 detects a radiated power and a reflected power for each frequency. Controller 7 measures reflected wave frequency characteristic 11 from the radiated power and the reflected power. Hereinafter, reflected wave frequency characteristic 11 for the microwaves at the first output power level is referred to as a first reflected wave frequency characteristic.

Next, controller 7 causes microwave generator 3 to perform frequency sweeping with microwaves at a second output power level (step S22). The second output power level is an output power level higher than the first output power level (for example, 250 W). By the frequency sweeping, the radiated power and the reflected power are detected in a similar manner, and reflected wave frequency characteristic 11 is measured. Hereinafter, reflected wave frequency characteristic 11 for the microwaves at the second output power level is referred to as a second reflected wave frequency characteristic. Controller 7 causes the two reflected wave frequency characteristics 11 to be stored in memory 8, and ends the sensing process.

Controller 7 returns the process to the flowchart shown in FIG. 7A. The controller detects all of cavity interior loss frequency bands 12 based on the two reflected wave frequency characteristics 11 (step S3).

Next, controller 7 estimates the amount of absorption power absorbed by heating target 2 (step S4). FIG. 7C shows a flow of an estimation process for an amount of absorption power (step S4 in FIG. 7A). As illustrated in FIG. 7C, in the estimation process for an amount of absorption power (step S4), controller 7 reads out, from memory 8, slope information related to a linear component (first coefficient) and slope information related to a non-linear component (second coefficient) according to the selected menu (step S41).

Controller 7 multiplies the radiated power detected by detector 6 by the first coefficient to obtain a linear component (step S42). Controller 7 multiplies the output power difference characteristic calculated from reflected wave frequency characteristic 11 measured in the sensing process by the second coefficient to obtain the quadratic curve for calculating a non-linear component (step S43).

Controller 7 combines the linear component and the non-linear component together to estimate the amount of absorption power absorbed by heating target 2 in one frequency band among the detected cavity interior loss frequency bands 12, and causes the information to be stored in memory 8 (step S44). Controller 7 repeatedly performs the processes of step S42 to S44 for all of cavity interior loss frequency bands 12 (step S45), and ends the estimation process for the amount of absorption power when the processes are performed for all of cavity interior loss frequency bands 12.

Controller 7 returns the process to the flowchart shown in FIG. 7A and determines initial heating conditions at the start of heating and next heating conditions during heating, that is, new heating conditions (step S5). Controller 7 determines the new heating conditions taking into consideration the heating efficiency and heating unevenness based on the information obtained in the estimation process for the amount of absorption power (step S4). Controller 7 executes a heating process based on the new heating conditions (step S6). Controller 7 stores the new heating conditions in memory 8 to update the heating conditions.

During heating, controller 7 checks a log (described later) (step S7) and checks whether or not the temperature of heating target 2 has reached a target temperature (step S8) based on the obtained information. Controller 7 continues the heating process (step S6) until the temperature of heating target 2 reaches the target temperature (No in step S8).

FIG. 7D shows a flow of a log checking process (step S7 in FIG. 7A). As illustrated in FIG. 7D, in the log checking process (step S7), controller 7 integrates the radiated power detected by detector 6 to calculate the total absorbed energy (amount of absorption power) by heating target 2 (step S71). Controller 7 estimates the temperature rise of heating target 2 based on the total absorbed energy (step S72).

Controller 7 returns the process to the flowchart shown in FIG. 7A. As illustrated in FIG. 7A, when the temperature of heating target 2 reaches the target temperature (Yes in step S8), controller 7 determines whether or not all the cooking stages have been completed based on the result of the integration and the estimated value of the temperature rise (step S9).

If there is a remaining cooking stage (No in step S9), controller 7 returns the process to the sensing process (step S2) and starts the next cooking stage. When all the cooking stages are completed (Yes in step S9), controller 7 ends the heating process.

As described above, the present exemplary embodiment makes it possible to estimate the temperature rise of heating target 2 accurately by obtaining a linear component and a non-linear component of the power loss consumed by heating chamber 1. As a result, it is possible to identify the progress of cooking accurately.

In addition, the present exemplary embodiment measures reflected wave frequency characteristic 11 once again during cooking to update the linear component and the non-linear component of the power loss. This enables appropriate cooking even when the position of heating target 2 shifts because of expansion or the like during cooking.

### INDUSTRIAL APPLICABILITY

The microwave treatment device according to embodiments of the present disclosure is applicable to various commercial use microwave treatment devices, such as drying devices, pottery-use heating devices, garbage disposers, semiconductor manufacturing devices, and chemical reaction devices, in addition to microwave ovens.

### REFERENCE MARKS IN THE DRAWINGS

1 heating chamber
2 heating target
3 microwave generator
4 amplifier
5 power feeder
6 detector
7 controller
8 memory
11 reflected wave frequency characteristic
12 cavity interior loss frequency band
13a, 13b, 13c characteristic line
14 data
15 quadratic curve

1. A microwave treatment device comprising:
a heating chamber configured to accommodate a heating target;
a microwave generator configured to generate microwaves having a given frequency in a predetermined frequency band;
an amplifier configured to amplify an output power level of the microwaves generated by the microwave generator;
a power feeder configured to irradiate the heating chamber with the microwaves amplified by the amplifier as a radiated power;
a detector configured to detect the radiated power and a reflected power of the radiated power, the reflected power returning from the heating chamber to the power feeder; and
a controller configured to control the microwave generator and the amplifier based on information from the detector, to control heating to the heating target, wherein:
the controller is configured to select a plurality of frequencies in the predetermined frequency band and to cause the microwave generator to generate microwaves of the selected frequencies;
the controller is configured to cause the amplifier to change the output power level of the microwaves and to supply the microwaves of one of a plurality of output power levels to the heating chamber;
the controller calculates, based on the radiated power and the reflected power, a component related to a housing of the microwave treatment device and a component obtained during heating, and combines the calculated components together, to calculate a power loss consumed by the heating chamber; and
the controller is configured to estimate an amount of absorption power absorbed by the heating target based on the power loss.

2. The microwave treatment device according to claim 1, wherein:
the controller is configured to measure a reflected wave frequency characteristic based on the radiated power and the reflected power;
the controller is configured to calculate a linear component of the power loss based on a first coefficient related to the housing of the microwave treatment device; and
the controller is configured to calculate a non-linear component of the power loss based on a second coefficient determined by the reflected wave frequency characteristic obtained during heating.

3. The microwave treatment device according to claim 2, wherein the controller is configured to calculate the non-linear component of the power loss by approximating a characteristic of the non-linear component of the power loss by a quadratic curve.

4. The microwave treatment device according to claim 3, wherein:
the controller is configured to cause the amplifier to change the output power level of the microwaves into a first output power level and a second output power level being higher than the first output power level, among the plurality of output power levels;
the controller is configured to measure a first reflected wave frequency characteristic for the microwaves of the first output power level, and a second reflected wave frequency characteristic for the microwaves of the second output power level; and
the controller is configured to obtain an output power difference characteristic being a difference between the first reflected wave frequency characteristic and the second reflected wave frequency characteristic, to use a coefficient determined according to the output power difference characteristic as the second coefficient, and to multiply the output power difference characteristic by the second coefficient to obtain the quadratic curve.

5. The microwave treatment device according to claim 1, wherein the controller is configured to multiply the amount of absorption power absorbed by a third coefficient determined according to a temperature rise characteristic indicating a relationship between the amount of absorption power and a temperature rise of the heating target, to estimate the temperature rise.

6. The microwave treatment device according to claim 2, wherein the controller is configured to calculate the linear component of the power loss separately for a case of defrosting heating ranging from a frozen state in which a temperature of the heating target is less than 0° C. to a defrosting state in which the temperature is at or around 0° C. and for a case of temperature-raising heating of raising the temperature in a defrosted state in which the temperature is higher than or equal to 0° C.

7. The microwave treatment device according to claim 6, wherein:
the controller deducts a heat of fusion required for the defrosting heating from the amount of absorption power to calculate a remaining amount of absorption power; and
the controller is configured to multiply the remaining amount of absorption power absorbed by a third coefficient determined according to a temperature rise characteristic indicating a relationship between the amount of absorption power and a temperature rise of the heating target, to estimate the temperature rise.

8. The microwave treatment device according to claim 2, wherein the controller is configured to update a heating condition as the heating proceeds, and to calculate the linear component and the non-linear component of the power loss each time the heating condition is updated.

9. The microwave treatment device according to claim 4, wherein:
the controller is configured to detect all frequency bands in which a difference between the first reflected wave frequency characteristic and the second reflected wave frequency characteristic exceeds a predetermined threshold value to be cavity interior loss frequency bands; and
the controller is configured to update the heating condition as cooking proceeds, and to calculate the linear component and the non-linear component of the power loss in all the cavity interior loss frequency bands each time the heating condition is updated.
